(19) United States
(12) Patent Application Publication
(10) Pub. No.: US 2009/0165347 A1
(43) Pub. Date: Jul. 2, 2009

(54) APPARATUS AND METHOD FOR DISPLAYING A SPIRIT BANNER

(75) Inventor: Scott Joey Rainnes, Boca Raton, FL (US)

Correspondence Address: KRUGLIAK, WILKINS, GRIFFITHS & DOUGHERTY CO, LPA, 4775 MUNSON STREET N.W., P.O. BOX 36963, CANTON, OH, 44735-6963, US

(73) Assignee: VENTURE 4 PARTNERS LLC., Boca Raton, FL (US)

(21) Appl. No.: 12/340,887

(22) Filed: Dec. 22, 2008

Related U.S. Application Data
(60) Provisional application No. 61/017,364, filed on Dec. 28, 2007.

(51) Int. Cl. G09F 17/00

(52) U.S. Cl. 40/607.13

(57) ABSTRACT

An apparatus and method for displaying a spirit banner of an individual includes a banner having an opening into which a grommet is inserted. A hook has an upper bend and a lower bend. The upper and lower bends each have an upwardly extending arm and a downwardly extending arm attached to one another. The upwardly extending arm of the upper bend is attached to the downwardly extending arm of the lower bend. The upwardly extending arm of the lower bend and the downwardly extending arm of the upper bend each have an end which is free of any attachment. The upwardly extending arm of the lower bend is disposed through the grommet of the banner. A loop worn by the individual captures the downwardly extending arm of the upper bend of the hook in order to secure the hook and the banner to the individual.

This application claims the benefit of U.S. Provisional Application No. 61/017,364, filed on Dec. 28, 2007.

### BACKGROUND OF THE INVENTION

1. Field of the Invention

The invention relates generally to spirit banners or team banners which are distributed or sold at sporting events such as baseball games, football games, hockey games, and basketball games as well as car racing events, and which are typically waved by fans at the sporting events in order to show support for their team. More particularly, the invention is directed to a spirit banner which includes a metal grommet having an opening which is placed over and around one end of an S-shaped hook which is in turn hooked onto the belt loop, waistband, or belt of the pants of an individual, in order to securely hold the banner so that it is not dropped, lost or stolen, and which S-hook serves as an attractive mount for displaying the banner at the side of the individual.

2. Background Art

Spirit banners or team banners have been sold at both racing and/or sporting events for many years. These banners are typically sold by third parties or the teams themselves at stands or booths located at the racing or sporting event. For example, spirit banners are often sold at merchandise stands or booths located in the concourse that typically surrounds baseball, basketball and football stadiums. In addition, these spirit banners can be sold by third parties outside of the sporting venue, such as by vendors having carts and the like.

These spirit banners or team banners are typically square or rectangular in shape and made of a cloth such as a cotton blend. The banners typically include the logo, name or number of the sport or racing team and also the colors associated with that particular team. During racing events the banners can be waved by the fans in order to cheer and show their support for a particular race-car or racing team. At sporting events such as basketball games or football games, the banners can also be waved to show fan support for the particular team. For example, these banners are typically waved by fans who are seated behind the basket at basketball arenas while a player from the opposing team is attempting a foul shot in order to distract the player and to possibly cause the player to miss the foul shot. Another example, is fans who are seated behind the goalposts at football stadiums who wave the banners when the opposing team is attempting a field goal or extra point in order to distract the kicker kicking the field goal and to possibly cause the player to miss the field goal or extra point.

Not only do the banners provide a way for the fans to display their support for their teams, racing, sporting, or otherwise, but they also provide a way for the fans to feel as if they are actually taking part in the game itself, by waving the banners to distract opposing players etc. at key times during the sporting event as set forth above. Therefore, the spirit banner provides an easy way for fans to show their support for their team and also serves as a cheering aid to be waved in the air during the sporting or racing event.

Problems associated with these prior art spirit banners are numerous and will be set forth below. First, these prior art spirit banners do not typically include any means for attaching the banner to the individual carrying the banner. Therefore, the individual who is carrying the banner must put the banner in a coat or pants pocket in order to transport the banner. This can lead to the banner falling from the pocket or even being taken from the pocket in which it is being carried. Loss of the banner is especially prevalent with younger individuals with whom such banners are quite popular. Another problem with these prior art spirit banners is that they offer no method for displaying the banner during transport or at games so that the individual can show their support for their team even when they are not waving the banner in the air. An individual can place an end of these prior art banners in a pants pocket or coat pocket and leave a portion of the banner displayed to the public, but this can also lead to the banners being stolen or pulled from the pocket or just falling out of the pocket by their own accord. Yet another problem associated with these prior art spirit banners or team banners is that because there is no means for attaching or securing the banner to the individual, when the banner is placed in a pocket or tied around a belt loop or other such method of attachment, the logo of the team is often upside-down or sideways which makes it difficult to be seen by other individuals, thus taking away the ability of the individual to show other individuals their team support. Even yet another problem associated with these prior art spirit banners or team banners, is that because they have no means for attachment in order to secure them to the individual carrying them, they must typically be held in the hand of the individual in between times when the banner is being waved in the air. If the banner is placed in a pocket or tied to a belt loop, the banner must be untied or retrieved from the pocket each time that the individual desires to wave the banner in the air to show support for their team.

Therefore, a need exists in the art for an improved spirit banner and an apparatus and method for displaying the banner that overcomes the deficiencies of the prior art spirit banner and/or team banners and which provides an efficient, cost-effective, visually pleasing method for securing the banner to the individual so that the banner is not easily lost or stolen and also provides an easy and effective way for the banner to be retrieved and waved by the individual during a sporting event so that the individual can show support for their team.

### SUMMARY OF THE INVENTION

The objectives of the present invention include providing an apparatus and method for displaying a spirit banner which includes a means for attaching the banner to the individual in order to deter loss of the banner during transport either to and from or at the sporting event.

Another objective of the present invention is to provide an apparatus and method for displaying a spirit banner which includes a means for attaching the banner to the individual which allows the banner to be properly displayed by the individual carrying the banner during sporting events or during travel to and from the event in order for the individual to show their support for their team.

Yet another objective of the present invention is to provide an apparatus and method for displaying a spirit banner that is inexpensive and efficient and allows for easy retrieval of the banner during the sporting event.

Yet even another objective of the present invention is to provide an apparatus and method for displaying a spirit banner which allows for secure mounting of the banner to the individual in order to minimize the likelihood of the banner being either lost or stolen.

A farther objective of the present invention is to provide an apparatus and method for displaying a spirit banner that is functional yet remains attractive and pleasing to the eye.

An even further objective of the present invention is to provide an apparatus and method for displaying a spirit banner which provides the individual an improved means for grasping the banner when the individual is waiving the banner.

These improvements are provided by the apparatus for displaying a spirit banner of an individual of the present invention which includes: a banner including an opening; a grommet having an opening and being inserted into the opening of the banner; a hook having an upper bend and a lower bend, the upper and lower bends each having an upwardly extending arm and a downwardly extending arm attached to one another; the upwardly extending arm of the upper bend is attached to the downwardly extending arm of the lower bend; the upwardly extending arm of the lower bend and the downwardly extending arm of the upper bend each have an end which is free of attachment; the upwardly extending arm of the lower bend is disposed through the grommet inserted into the opening of the banner; a loop is worn by the individual; the downwardly extending arm of the upper bend of the hook is disposed through the loop in order to secure the hook and the banner to the loop and to the individual.

These improvements are also provided by the method for displaying a spirit banner of an individual of the present invention which includes: providing a banner; the banner includes an opening; a grommet having an opening is inserted into the opening of the banner; providing a hook having an upper bend and a lower bend; the upper and lower bends each having an upwardly extending arm and a downwardly extending arm attached to one another; the upwardly extending arm of the upper bend is attached to the downwardly extending arm of the lower bend; the upwardly extending arm of the lower bend and the downwardly extending arm of the upper bend each have an end which is free of attachment; inserting the upwardly extending arm of the lower bend of the hook through the opening of the grommet in order to secure the banner to the hook; providing a loop worn by the individual; inserting the downwardly extending arm of the upper bend of the hook through the loop in order to secure the hook and the banner to the loop and to the individual.

### DRAWINGS

An exemplary embodiment of the present invention, illustrating the best mode in which the applicant has contemplated applying the principles, are set forth in the following description and are shown in the drawings.

FIG. 1 is a perspective view of a prior art spirit banner;

FIG. 2 is a perspective view of the apparatus and method for displaying a spirit banner of the present invention, showing the spirit banner attached to the S-Hook attachment means;

FIG. 3 is an enlarged perspective view of a portion of the apparatus for displaying a spirit banner or team banner of the present invention, showing the S-Hook attachment means;

FIG. 4 is a perspective view of the apparatus and method for displaying a spirit banner of the present invention, showing the spirit banner attached to the S-Hook attachment means which is in turn securely fastened to the belt loop of the pants of the individual; and

FIG. 5 is an enlarged side elevational view of a portion of the apparatus for displaying a spirit banner of the present invention with hidden portions in ghost, showing the subtle curvature of the upwardly and downwardly extending arms of the hook.

Similar numerals refer to similar parts throughout the drawings.

### DESCRIPTION OF THE PREFERRED EMBODIMENT

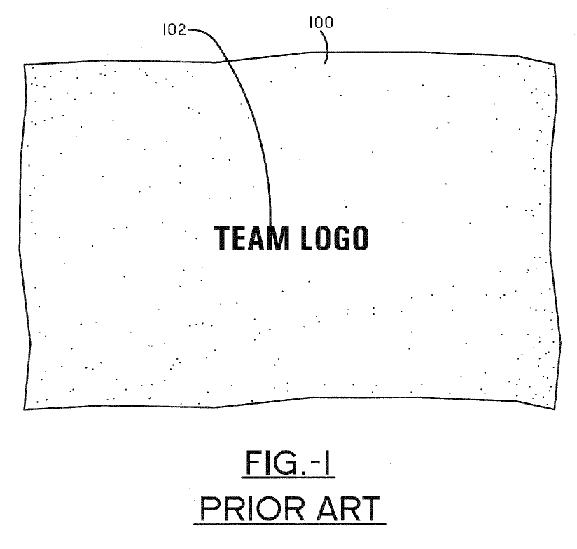

In order to better understand the apparatus and method for displaying a spirit banner of the present invention, a prior art spirit banner is shown in FIG. 1 and will be described in detail below.

Prior art spirit banner 100 is a generally rectangular or square piece of cloth, such as a cotton, nylon or a blend. Spirit banner 100 typically includes a logo 102 of a team. The logo can be oriented on the banner in any direction. Prior art spirit banner 100 is typically folded and carried in a coat or pants pocket (not shown) when the banner is being transported by the individual (not shown), such as to and from the sporting event.

As mentioned above, prior art spirit banner 100 is typical of the prior art spirit banners and demonstrates many of the problems which have become associated with these types of banners. First, prior art spirit banner 100 does not include any means for attaching or securing the banner to the individual. Therefore, the individual who is carrying the banner is forced to place the banner in a coat or pants pocket (not shown) in order to transport the banner to and from the sporting or racing event. Thus prior art spirit banner 100 is prone to falling from the pocket or even being taken from the pocket which typically leads to loss of the banner. As set forth above, this is especially prevalent with younger individuals with whom such banners are quite popular. Another problem with spirit banner 100 is that it offers no method or means for displaying the banner on the individual so that the individual can show their support for their team even when they are not waving the banner in the air. Yet another problem associated with prior art spirit banner 100 is that because there is no means for attaching or securing the banner to the individual, when the banner is placed in a pocket or tied around a belt loop or other such method of attachment, logo 102 is often upside-down or sideways which makes it difficult to be read or seen by other individuals, thus taking away the ability of the individual to show other individuals their team support. Even yet another problem associated with prior art spirit banner 100 is that because it has no means to attach or secure it to the individual it must typically be held in the hand of the individual in between times when the banner is being waved in the air. If prior art spirit banner 100 is placed in a pocket (not shown) or tied to a belt loop (not shown), the banner must be untied from the belt-loop or retrieved from the pocket each time that the individual desires to wave the banner in the air to show support for their team. The present invention overcomes these problems, as will now be described.

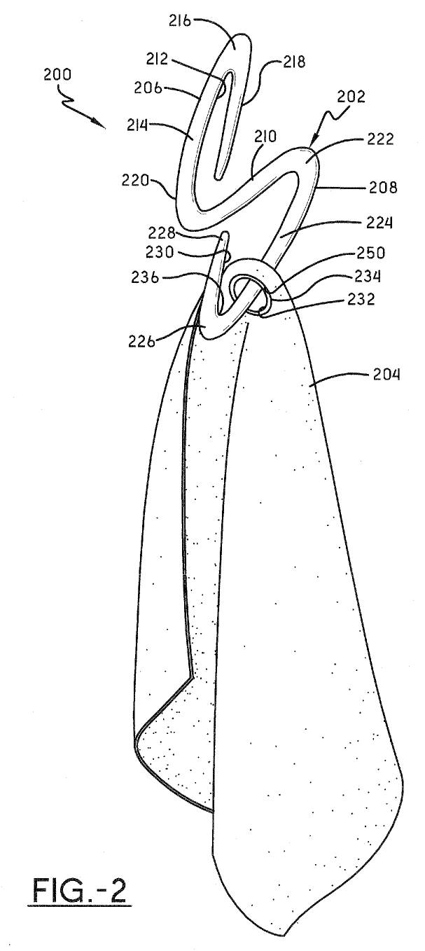

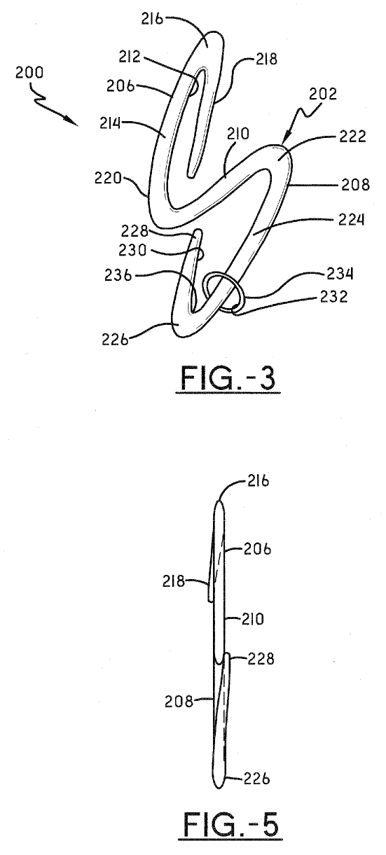

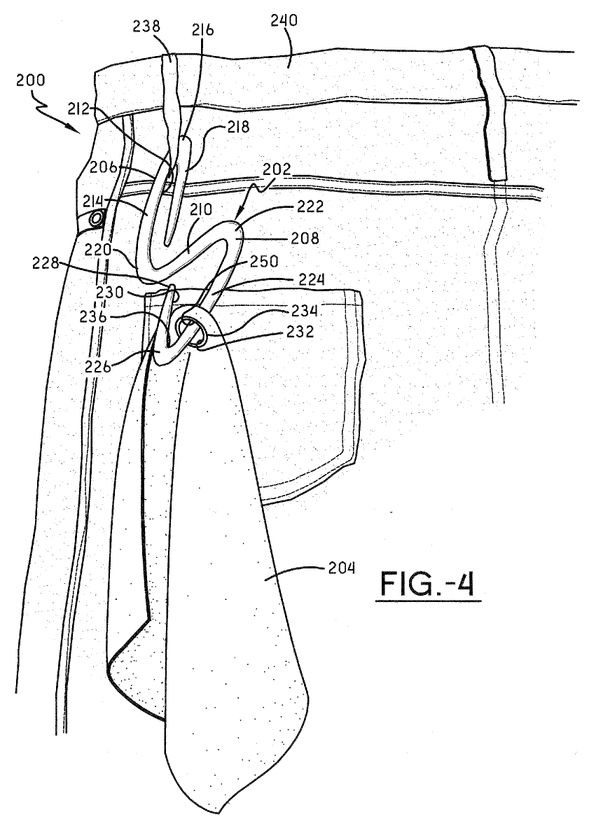

Turning now to FIG. 2, the apparatus and method for displaying a spirit banner is shown generally as reference numeral 200 and includes an S-hook attachment means 202 and a spirit banner 204. Spirit banner 204, like prior art spirit banner 100 is a generally rectangular or square piece of cloth, such as cotton or nylon or a blend of the two. With additional reference to FIG. 3, a key feature of the present invention, S-hook attachment means 202, is shown as a generally S-shaped hook or attachment means having a generally circular or elliptical cross section and formed from steel or other suitable rigid material such as plastic. S-hook attachment means 202 includes an upper bend 206 and a lower bend 208. Upper bend 206 is connected to lower bend 208 via a central portion 210. Central portion 210 also has a generally circular cross section and a generally Z-shape rotated backwards ninety degrees. More particularly, central portion 210 has an L-shaped first portion 220 which is connected to upper bend 206. Central portion 210 also has an L-shaped second portion 222 which is connected to lower bend 208. Upper bend 206 has a generally elongated and inverted U-shape including an upwardly extending arm 214, a generally inverted U-shaped top portion 216, and a downwardly extending arm 218. Downwardly extending arm 218 includes a subtle S-shaped curvature away from a vertical axis 260 bisecting central portion 210 as shown in FIG. 5. This curvature allows for better securement of S-hook attachment means 202 to a belt loop, belt or waistband of the individual as set forth below. A space 212 is formed between upwardly extending arm 214, U-shaped top portion 216, and downwardly extending arm 218, for engaging the belt loop of a pair of jeans, as shown in FIG. 4. Lower bend 208 of S-hook attachment means 202 has a generally elongated U-shape including a downwardly extending arm 224 connected to a U-shaped bottom portion 226, which is in turn connected to an upwardly extending arm 228. Upwardly extending arm 228 includes a subtle S-shaped curvature away from a vertical axis 260 bisecting central portion 210 as shown in FIG. 5. This curvature allows for more simplified and better attachment of spirit banner 204 to S-hook attachment means 202 as set forth below. A space 230 is formed between downwardly extending arm 224, U-shaped bottom portion 226, and upwardly extending arm 228. Upwardly extending arm 228 terminates near central portion 210 of hook attachment means 202. Preferably the space between said upwardly extending arm 228 and central portion 210 of hook attachment means 202 is from about 3 millimeters to about 7 millimeters. Upwardly extending arm 228, U-shaped bottom portion 226, and downwardly extending arm 224 have a diameter which is generally smaller than the interior diameter of an opening 232 of a circular grommet 234 which is fixedly attached to spirit banner 204, about an opening 250 in the spirit banner. A notch 236 is formed in the upper surface of U-shaped bottom portion 226.

Because of the manner in which S-hook attachment means 202 and spirit banner 204 are formed, an insignia is preferably formed and/or adhered to the surface of the spirit banner in the center of the banner and oriented perpendicularly below grommet 234. In this manner, when spirit banner 204 is hung on S-hook attachment means 202, the logo can be easily seen and read by individual passersby.

Having now described the structure and arrangement of apparatus for displaying a spirit banner 200 of the present invention a method for using the apparatus is shown in FIG. 4 and will now be described below.

Upper bend 206 of S-hook attachment means 202 is disposed through a belt loop 238 of a pair of jeans 240 such that the belt loop is captured in space 212 between upwardly extending arm 214 and downwardly extending arm 218. Space 212 is preferably about 5 millimeters to about 11 millimeters across so that belt loop 238 becomes wedged into the space. The force of gravity acting on the weight of S-hook attachment means 202 and spirit banner 204 forces belt loop 238 into inverted U-shaped top portion 216 such that S-shaped hook 202 is securely attached to the belt loop.

Spirit banner 204 including grommet 234 and opening 232 is secured to S-hook attachment means 202 by placing the grommet over upwardly extending arm 228 of lower bend 208. The force of gravity acting on spirit banner 204 causes grommet 234 to seat in the notch formed in the upper surface of U-shaped bottom portion 226. Because the diameter of S-hook attachment means 202 at U-shaped bottom portion 226 is only slightly less than the inner diameter of opening 232 of grommet 234 and because upwardly extending arm 228 extends upwardly from the notch formed in U-shaped bottom portion 226, the grommet and the spirit banner are prohibited from slipping off of the S-hook attachment means. Also, because upwardly extending arm 228 terminates near central portion 210, it minimizes the risk of spirit banner 204 and grommet 234 slipping off of S-hook attachment means 202.

When the individual wearing the spirit banner desires to remove spirit banner 204, for example when the individual desires to wave the banner during a sporting event, the individual can easily grasp the banner and pull it and grommet 234 upwardly over upwardly extending arm 228 in order to free the banner from the S-hook attachment means. Once the individual has finished waving the banner, the individual can easily replace the banner back onto the S-hook attachment 202 by placing grommet 234 over upwardly extending arm 228. Moreover, grommet 234 and opening 232 provide additional functionality to the present invention as they serve as an easy and efficient means for the individual waving spirit banner 204 to better grasp the banner, such as placing an index finger through the opening in the grommet or pinching the banner at the opening in the grommet when it is being waved.

As can be seen by the description set forth above, S-hook attachment means 202 and spirit banner 204 provide an efficient, cost-effective, visually pleasing method for securing spirit banner 204 to the individual so that the banner is not easily lost or stolen and also provides an easy and effective way for the banner to be retrieved by the individual for waving the banner during a sporting event so that the individual can show support for their team.

Of course, other configurations and arrangements of the various components of apparatus and method for displaying a spirit banner 200 of the present invention will be evident to those having skill in the relevant art, without changing the overall concept of the invention. More particularly, different shapes of S-hook attachment means 202 could be utilized without changing the overall concept of the invention. For example, an overall Z-shape could be utilized in place of an S-shape. In addition, other shapes of grommets, such as polygonal or oval shapes could also be utilized without affecting the overall concept of the present invention. Moreover, spirit banner 204 could be made from any suitable material such as leather, microfiber, or other suitable cloth, without changing the overall concept of the invention.

The present invention has been described with reference to a specific embodiment. It is to be understood that this illustration is by way of example and not by way of limitation. Potential modifications and alterations will occur to others upon a reading and understanding of this disclosure, and it is understood that the invention includes all such modifications and alterations and equivalents thereof.

Accordingly, the apparatus and method for displaying a spirit banner of the present invention is simplified, provides an effective, safe, inexpensive, and efficient apparatus and method for displaying a spirit banner which achieves all the enumerated objectives, provides for eliminating difficulties encountered with prior art spirit banners, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the apparatus and method for displaying a spirit banner is constructed, arranged and used, the characteristics of the construction and arrangement, and the advantageous, new and useful results obtained; the new and useful structures, devices, elements, arrangements, parts and combinations, and methods are set forth in the appended claims.

What is claimed is:

1. An apparatus for displaying a spirit banner of an individual comprising:
a) a banner, said banner including an opening, a grommet having an opening and being inserted into said opening of said banner;
b) a hook having an upper bend and a lower bend, said upper and lower bends each having an upwardly extending arm and a downwardly extending arm attached to one another, said upwardly extending arm of said upper bend attached to said downwardly extending arm of said lower bend, said upwardly extending arm of said lower bend and said downwardly extending arm of said upper bend each having an end which is free of attachment, said upwardly extending arm of said lower bend disposed through said grommet inserted into said opening of said banner; and
c) a loop worn by said individual, said downwardly extending arm of said upper bend of said hook being disposed through said loop in order to secure the hook and the banner to the loop and to the individual.

2. The apparatus for displaying a spirit banner of claim 1, wherein said hook includes a shape selected from the group consisting of a generally O-Shape, a generally S-shape and a generally Z-shape.

3. The apparatus for displaying a spirit banner of claim 1, wherein said hook farther includes a generally horizontally extending central portion connected between said upwardly extending arm of said upper bend of said hook and said downwardly extending arm of said lower bend of said hook.

4. The apparatus for displaying a spirit banner of claim 1, wherein said grommet is circular-shaped.

5. The apparatus for displaying a spirit banner of claim 4, wherein said upwardly extending arm of said lower bend of said hook includes a diameter that is less than a diameter of said opening of said grommet.

6. The apparatus for displaying a spirit banner of claim 1, wherein said banner is square and said opening in said banner is located in a corner near a periphery of said banner, the banner including an insignia on a surface of said banner, said insignia being placed perpendicularly beneath said grommet.

7. The apparatus for displaying a spirit banner of claim 3, wherein said upwardly extending arm of said lower bend and said downwardly extending arm of said upper bend each include an S-shaped curvature away from a vertical axis of said central portion of said hook.

8. The apparatus for displaying a spirit banner of claim 5, wherein said upper bend of said hook includes a space of from about 5 millimeters to about 11 millimeters between said upwardly extending arm of said upper bend and said downwardly extending arm of said upper bend.

9. The apparatus for displaying a spirit banner of claim 5, wherein said lower bend of said hook includes a notch connected between said downwardly extending arm and said upwardly extending arm of said lower bend, a diameter of said notch is=a diameter of said opening of said grommet.

10. The apparatus for displaying a spirit banner of claim 3, wherein said upwardly extending arm of said lower bend terminates near said central portion of said hook, in order to prevent the banner from sliding off of said upwardly extending arm.

11. A method for displaying a spirit banner of an individual comprising the steps of:
a) providing a banner, said banner including an opening, a grommet having an opening being inserted into said opening of said banner;
b) providing a hook having an upper bend and a lower bend, said upper and lower bends each having an upwardly extending aim and a downwardly extending arm attached to one another, said upwardly extending arm of said upper bend attached to said downwardly extending arm of said lower bend, said upwardly extending arm of said lower bend and said downwardly extending arm of said upper bend each having an end which is free of attachment;
c) inserting said upwardly extending arm of said lower bend of said hook through said opening of said grommet in order to secure the banner to the hook;
d) providing a loop worn by said individual; and
e) inserting said downwardly extending arm of said upper bend of said hook through said loop in order to secure the hook and said banner to the loop and to the individual.

12. The method for displaying a spirit banner according to claim 11, wherein said hook includes a shape selected from the group consisting of a generally O-shape, a generally S-shape and a generally Z-shape.

13. The method for displaying a spirit banner according to claim 11, wherein said hook further includes a generally horizontally extending central portion connected between said upwardly extending arm of said upper bend of said hook and said downwardly extending arm of said lower bend of said hook.

14. The method for displaying a spirit banner according to claim 11 wherein said grommet is circular-shaped.

15. The method for displaying a spirit banner according to claim 14, wherein said upwardly extending arm of said lower bend of said hook includes a diameter that is less than a diameter of said circular opening of said grommet.

16. The method for displaying a spirit banner according to claim 11, wherein said banner is square and said opening in said banner is located in a corner near a periphery of said banner, the banner including an insignia on a surface of said banner, said insignia being placed perpendicularly beneath said grommet.

17. The method for displaying a spirit banner of claim 13, wherein said upwardly extending arm of said lower bend and said downwardly extending arm of said upper bend each include an S-shaped curvature away from a vertical axis of said central portion of said hook.

18. The method for displaying a spirit banner of claim 15, wherein said upper bend of said hook includes a space of from about 5 millimeters to about 11 millimeters between said upwardly extending arm and said downwardly extending arm of said upper bend.

19. The method for displaying a spirit banner of claim 15, wherein said lower bend of said hook includes a notch connected between said downwardly extending arm and said upwardly extending arm of said lower bend, a diameter of said notch is=a diameter of said opening of said grommet.

20. The method for displaying a spirit banner of claim 13, wherein said upwardly extending arm of said lower bend terminates near said central portion of said hook, in order to prevent the banner from sliding off of said upwardly extending arm.
